(19) United States
(12) Patent Application Publication
(10) Pub. No.: US 2006/0041816 A1
(43) Pub. Date: Feb. 23, 2006

(54) Method for designing optimum space-time code in a hybrid automatic repeat request system

(75) Inventors: Sung-Kwon Hong, Seoul (KR); Chang-Ho Suh, Sungnam-si (KR); Young-Kwon Cho, Suwon-si (KR); Young-Kyun Kim, Sungnam-si (KR); Dong-Seek Park, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/205,726

(22) Filed: Aug. 17, 2005

(30) Foreign Application Priority Data
Aug. 17, 2004 (KR) 2004-0064498

(51) Int. Cl. H04L 1/18

(52) U.S. Cl. 714/749

(57) ABSTRACT

A method for designing an optimum STC in an HARQ system is provided, in which k^{th} codes are detected which maximize the minimum squared Euclidean distance of the signal matrix of a combination code created by combining first to (k−1)^{th} codes with a k^{th} code. A k^{th} code whose signal matrix has a maximum minimum determinant is selected as the k^{th} retransmission code.

### PRIORITY

This application claims priority under 35 U.S.C. § 119 to an application entitled “Method Of Designing Optimum Space-Time Code In A Hybrid Automatic Repeat Request System” filed in the Korean Intellectual Property Office on Aug. 17, 2004 and assigned Serial No. 2004-0064498, the contents of which are incorporated herein by reference.

### BACKGROUND OF THE INVENTION

1. Field of the Invention

The present invention relates to a method for designing an optimum space-time code (STC) in a multiple-input multiple-output (MIMO) hybrid automatic repeat request (HARQ) system.

2. Description of the Related Art

An automatic repeat request scheme (ARQ) is an error control mechanism in which a receiver checks transmission errors in a frame received on a communication channel and upon detection of errors, automatically requests a retransmission from the transmitter, which retransmits the frame. Therefore, robustness against errors on the communication channel is increased. The error check is performed by means of an error detection code that the transmitter has attached to an information bit stream.

In comparison, an error correction code is created by adding additional information to an original information frame and the receiver corrects channel errors using only the received frame.

The ARQ scheme can be combined with an error correction code in many ways, including the following:

(1) When the receiver detects errors in an error-correction coded frame, the transmitter retransmits the same frame as the original frame and the receiver decodes the retransmission frame independently.

(2) When the receiver detects errors in an error-correction coded frame, the transmitter retransmits the same frame as the original frame and the receiver decodes the retransmission frame using the previous received frame. At decoding, the previous frame and the current frame (i.e. the retransmission frame) are soft-combined by “chase combining”. From the transmitter's point of view, the two frames are exactly the same, but they arrive with different values at the receiver due to distortion and noise on the channel. The receiver decodes by calculating the arithmetic average of the previous frame and the current frame. This type of decoding is called “chase combining”.

(3) When the receiver detects errors in an error-correction coded frame, the transmitter transmits a different frame from the transmitted frame at retransmission. The retransmission frame is different in the sense that it is encoded in a different coding method. To be more specific, the same information bits are encoded in a different coding method and this frame is transmitted at retransmission. The retransmission frame is so designed that code combining of the previous frame with the retransmission frame outperforms chase combining.

A brief overview of chase combining is presented below, with reference to FIG. 1A, which is a diagram illustrating a signal flow for the operation of an ARQ system using chase combining in the absence of errors in a received frame.

Referring to FIG. 1A, the transmitter encodes a P^{th} frame and transmits the P^{th} frame in step 101. In step 103, the receiver decodes the received P^{th} frame and checks errors in the P^{th} frame. As described before, the error check is performed using an error detection code. In the absence of errors in the P^{th} frame, the receiver transmits an acknowledgement (ACK) signal to the transmitter in step 105. The transmitter then encodes a (P+1)^{th} frame and transmits the (P+1)^{th} frame in step 107. In step 109, the receiver decodes the received (P+1)^{th} frame and checks errors in the (P+1)^{th} frame. In the absence of errors in the (P+1)^{th} frame, the receiver transmits an ACK signal to the transmitter in step 111.

FIG. 1B is a diagram illustrating a signal flow for the operation of the ARQ system using chase combining in the presence of errors in a received frame. Referring to FIG. 1B, the transmitter encodes a P^{th} frame and transmits it in step 121. In step 123, the receiver decodes the received P^{th} frame and checks errors in the P^{th} frame. Also, the receiver stores the received P^{th} frame as frame P_1 in a memory. Upon detection of errors in the P^{th} frame, the receiver transmits a non-acknowledgement (NACK) signal to the transmitter in step 125. The transmitter then encodes the P^{th} frame using the same code as for the previous transmitted P^{th} frame and retransmits it, instead of transmitting a (P+1)^{th} frame in step 127. In step 129, the receiver combines the retransmission frame (i.e., frame P_2) with frame P_1, for decoding and checks errors in the combined frame. In the absence of errors, the receiver transmits an ACK signal to the transmitter in step 131. On the contrary, in the presence of errors, the receiver transmits a NACK signal again to the transmitter and the transmitter retransmits the P^{th} frame. As described above, a retransmission frame is identical to an initial transmission frame in chase combining.

Meanwhile, the third retransmission method can be considered in two ways. First, the receiver decodes the retransmission frame independently, without the aid of the previous transmitted frame. Although code combining provides a coding gain, decoding using only the retransmission frame makes it possible to cope with various communication channel conditions.

A Second, way is that the receiver cannot decode the retransmission frame independently. Since a retransmission frame typically delivers an amount of additional information that is too small to decode the whole information frame with, independent decoding is impossible at the receiver although the retransmission frame may be transmitted in a smaller unit, compared to other retransmission schemes. This scheme is called incremental redundancy (IR). In general, IR performs excellently in terms of transmission throughput.

Active studies have recently been conducted on communications using multiple antennas at both the transmitter and the receiver. The multiple transmit/receive antenna scheme is called multiple-input multiple-output (MIMO). The MIMO environment is expected to yield higher channel capacity than a single-input single-output (SISO) environment. Thus, the MIMO scheme is under study as a promising scheme for future-generation communication systems.

The MIMO scheme is a kind of STC scheme. According to the STC scheme, a signal encoded in a predetermined coding method is transmitted through a plurality of transmit antennas so that coding in the time domain is extended to the frequency domain. As a result, a lower error rate is achieved.

Since the introduction of the concept of space-time trellis codes (STTC) by Tarokh, continuous efforts have been made to improve STC performance. Tarokh found out that STTC performance is determined by the minimum determinant of a signal matrix. Baro et. al. detected an optimum code that maximizes the minimum determinant by searching all possible generator coefficients for the Tarokh STTC structure. Thereafter, Yan et. al. presented a novel code based on a performance criterion that maximizes a determinant in a general term as well as taking the minimum determinant into account. It is known that Yan's STTC performs best for a single receive antenna.

For two or more receive antennas, due to multipath fading of a channel, as the number of receive antennas increases, channel distortion is modeled as additive white Gaussian noise (AWGN) according to the central limit theorem. Based on this fact, Chen et. al. stated that the minimum squared Euclidean distance dominates performance under AWGN, rather than the minimum determinant. Chen's STTC is known to provide the best performance for two or more receive antennas.

In an STC system with n transmit antennas and m receive antennas, error probability and STC performance are determined according to the following criteria in a slow static fading channel environment.

If an STC-coded sequence transmitted on a channel (or an STC matrix) is denoted by c and a distortion-caused erroneously decodable sequence (i.e. an error sequence for c) is denoted by e, then, c and e are expressed as Equation (1):

$$\begin{matrix}c = ( \begin{matrix}{c}_{1}^{1} , & {c}_{2}^{1} , & … , & {c}_{l}^{1} \\ {c}_{1}^{2} , & {c}_{2}^{2} , & … , & {c}_{l}^{2} \\ & … & & \\ {c}_{1}^{n} , & {c}_{2}^{n} , & … & {c}_{l}^{n}\end{matrix} ) , \\ e = ( \begin{matrix}{e}_{1}^{1} , & {e}_{2}^{1} , & … , & {e}_{l}^{1} \\ {e}_{1}^{2} , & {e}_{2}^{2} , & … , & {e}_{l}^{2} \\ & … & & \\ {e}_{1}^{n} , & {e}_{2}^{n} , & … & {e}_{l}^{n}\end{matrix} )\end{matrix} \qquad ( 1 )$$

where the number of the rows in the matrices is equal to that of the number of transmit antennas, and the number of the columns is equal to the length of the STC code.

If A=(c−e)(c−e)* (* denotes a transpose conjugate) a signal matrix having rank r and the determinant is represented as Det, the STC error probability is computed by Equation (2):

$$P ( c -> e ) = {( Det )}^{- m} {( \frac{{E}_{s}}{4 {N}_{o}} )}^{- rm} \qquad ( 2 )$$

where r denotes the rank of the matrix A, Eₛ denotes symbol energy and N₀ denotes noise.

As noted from Equation (2), to minimize the error probability, two criteria should be satisfied: the signal matrix should be full rank; and the minimum determinant of the signal matrix should be maximized.

The above error performance is determined according to design criteria which vary depending on the number of receive antennas. As the number of receive antennas increases, channel distortion is approximate to the effect of AWGN noise according to the central limit theorem. That is, the channel becomes similar to an AWGN channel, and not the minimum determinant but the minimum squared Euclidean distance serves as a performance criterion for the AWGN channel. The minimum squared Euclidean distance is equivalently the trace of the signal matrix (i.e. the sum of the diagonal elements). In this case, the rank criterion is less strict so that a full rank is not a requisite and a rank of 2 or higher suffices.

The HARQ scheme is a combination of ARQ and error correction coding.

As described above, for implementation of a MIMO-HARQ system that enables independent decoding of a retransmission frame and achieves a combining gain by using a different STC from that of an initial transmission frame for the retransmission frame, the STC must be designed based on the above-described performance criteria.

The present invention as described below pertains to the third retransmission method, particularly to independent decoding using a retransmission frame only.

### SUMMARY OF THE INVENTION

An object of the present invention is to substantially solve at least the above problems and/or disadvantages and to provide at least the advantages below. Accordingly, an object of the present invention is to provide a method for designing an optimum STC that outperforms chase combining, appropriately taking into account performance criteria which depend on the number of transmit/receive antennas in a MIMO-HARQ system.

Another object of the present invention is to provide a method for optimizing a retransmission STC in a MIMO-HARQ system.

A further object of the present invention is to provide a method for optimizing a retransmission STC in a MIMO-HARQ system that enables independent decoding of a retransmission frame and achieves a combining gain by using a different STC from that of an initial transmission frame for the retransmission frame.

The above objects are achieved by providing a method for designing an optimum STC in an HARQ system.

According to one aspect of the present invention, in a method for designing an STC for a k^{th} retransmission in an HARQ system, k^{th} codes are detected which maximize the minimum squared Euclidean distance of the signal matrix of a combination code created by combining first to (k−1)^{th} codes with a k^{th} code. A k^{th} code whose signal matrix has a maximum minimum determinant is selected as the k^{th} retransmission code.

According to another aspect of the present invention, in a method for designing an STC for a k^{th} retransmission in an HARQ system, k^{th} codes are detected which maximize the minimum squared Euclidean distance of the signal matrix of a combination code created by combining first to (k−1)^{th} codes with a k^{th} code. A k^{th} code whose signal matrix has a minimum squared Euclidean distance is selected as the k^{th} retransmission code.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are diagrams illustrating signal flows for operations of an ARQ system using chase combining;

FIG. 2 is a block diagram of a MIMO-HARQ system according to an embodiment of the present invention;

FIG. 3 is a diagram illustrating in detail the structure of an STTC coder;

FIG. 4 illustrates the structure of an STTC coder for generating 4-state Yan's STTC for two transmit antennas and QPSK;

FIG. 5 is a flowchart illustrating a procedure for designing an optimum STC in a MIMO-HARQ system according to an embodiment of the present invention;

FIG. 6 is a diagram illustrating a signal flow for the operation of an HARQ system according to an embodiment of the present invention;

FIG. 7 is a graph comparing in terms of performance a retransmission scheme using a 32-state STTC of Table 1 with a retransmission scheme in which Yan's code is chase-combined;

FIG. 8 is a graph comparing in terms of performance a retransmission scheme using a 32-state STTC of Table 2 with a retransmission scheme in which Chen's code is chase-combined; and

FIG. 9 is a graph illustrating the throughputs of chase combining of Yan's code (32 state 1rx), 32-state of Table 1 (32 state new 1rx), chase combining of Chen's code (32 state 2rx), and 32-state of Table 2 (32 state new 2rx).

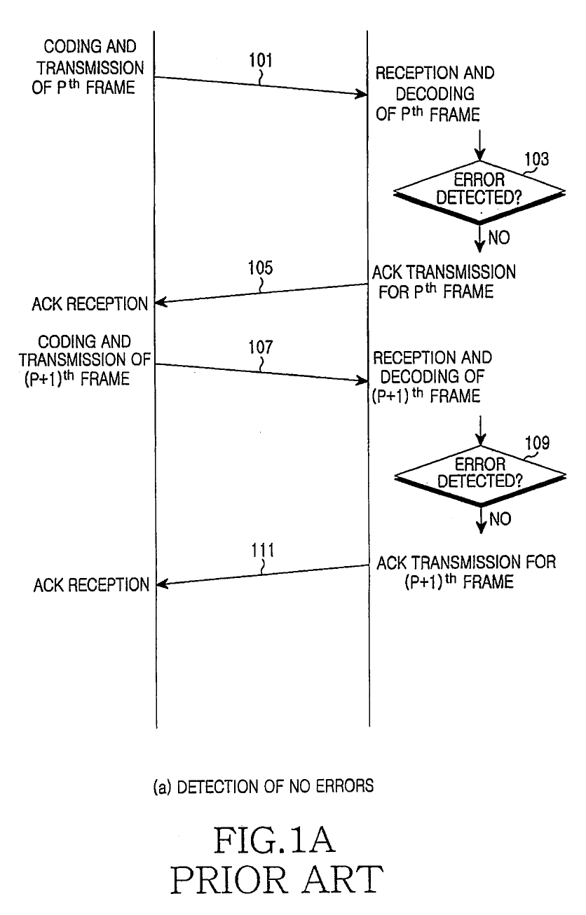

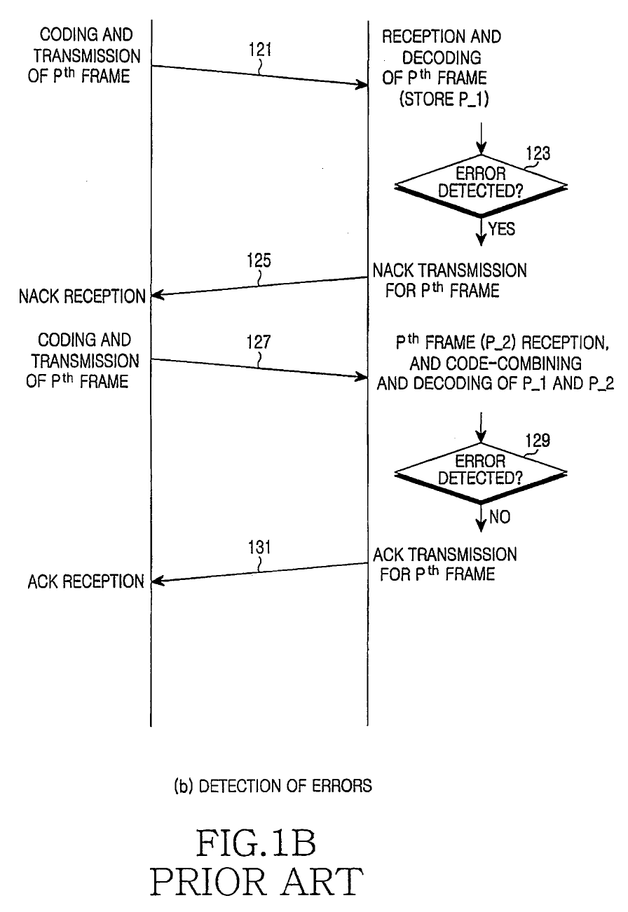

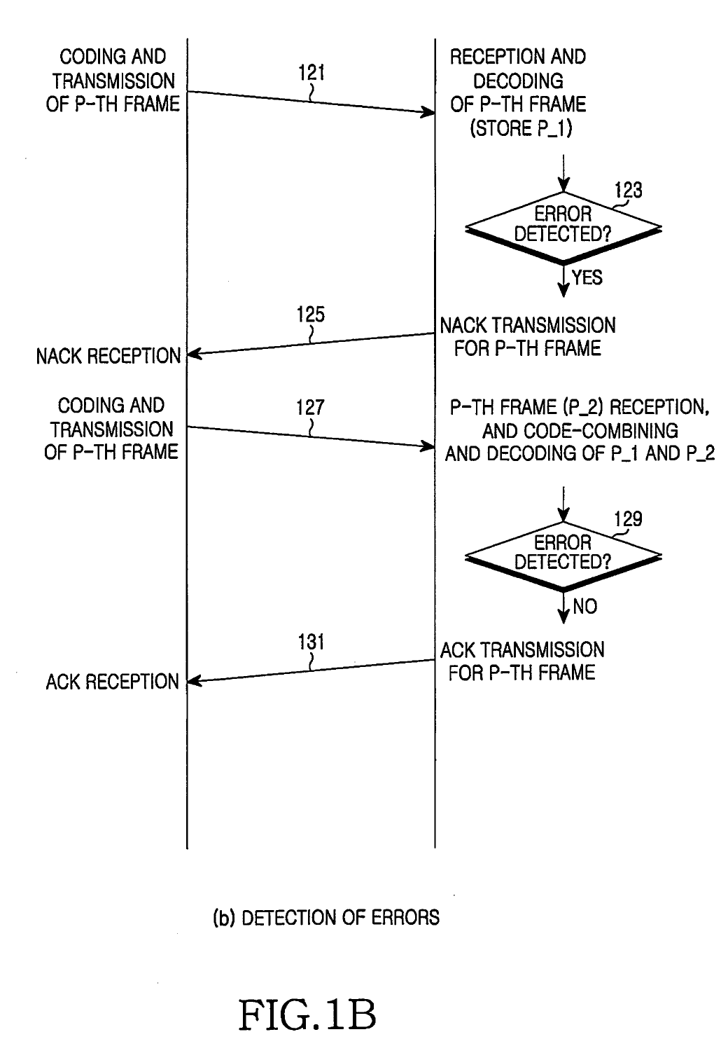

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a method for designing an optimum STC that outperforms chase combining, appropriately taking into account performance criteria which are determined according to the number of transmit/receive antennas in a MIMO HARQ system.

The present invention as described below is applicable to multiple access schemes including frequency division multiple access (FDMA), time division multiple access (TDMA), code division multiple access (CDMA), and orthogonal frequency division multiplexing (OFDM).

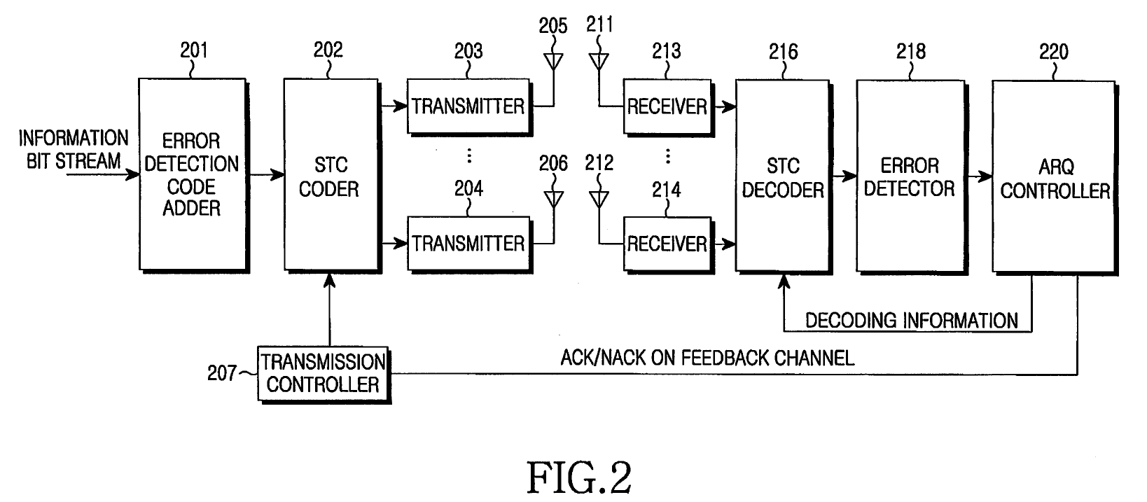

FIG. 2 is a block diagram of a MIMO-HARQ system according to an embodiment of the present invention.

Referring to FIG. 2, a transmitter includes an error detection code adder 201, an STC coder 202, first through n^{th} transmitters 203 to 204, first through n^{th} transmit antennas 205 to 206, and a transmission controller 207. A receiver includes first through m^{th} receive antennas 211 to 212, first through m^{th} receivers 213 to 214, an STC decoder 216, an error detector 218, and an ARQ controller 220. While the number of transmit antennas is assumed to be different from that of receive antennas, needless to say, they can be identical.

For transmission, the error detection code adder 201 attaches a predetermined error detection code to an information bit stream received on a frame basis. The error detection code serves to check errors in the frame. For example, it can be a cyclic redundancy check (CRC) code.

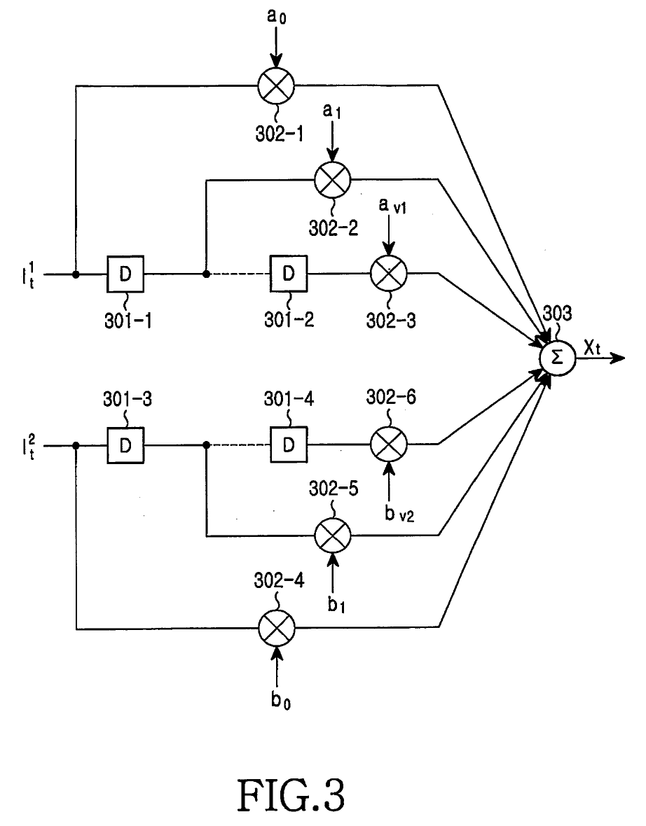

The STC coder 202 encodes the frame received from the error detection code adder 201 to a predetermined trellis code under the control of the transmission controller 207. The STC coder 202 is provided with, for example, an STTC coder as illustrated in FIG. 3 and encodes the frame after setting generator coefficients for the STTC coder according to a retransmission number (including an initial transmission) received from the transmission controller 207. The STC coder 202 outputs complex symbols mapped to signal points on the constellation of a predetermined modulation scheme. The modulation scheme can be one of binary phase shift keying (BPSK), quadrature phase shift keying (QPSK), 8ary quadrature amplitude modulation (8QAM), and 16ary quadrature amplitude modulation (16QAM). One bit (s=1) is mapped to one complex signal in BPSK, two bits (s=2) to one complex signal in QPSK, three bits (s=3) to one complex signal in 8QAM, and four bits (s=4) to one complex signal in 16QAM.

The transmission controller 207 keeps a table that preserves generator coefficients for the STTC coder with respect to retransmission numbers. According to the present invention, the transmission controller 207 has a generator coefficient table such as Table 1 or Table 2. Table 1 and Table 2 list generator coefficients for an optimized STC coder according to the present invention. The transmission controller 207 monitors an ACK/NACK signal received on a feedback channel from the receiver, reads generator coefficients for the STTC coder from the table based on the ACK/NACK signal, and provides the generator coefficients to the STC coder 202. In this way, the STC coder 202 generates a different code using different generator coefficients for the STTC coder.

Meanwhile, the transmitters 203 to 204 each modulate a baseband signal received from the STC coder 202 to a radio frequency (RF) signal and transmit the RF signal through a corresponding transmit antenna.

For reception, the first through m^{th} receive antennas 211 to 212 receive signals from the transmit antennas 205 to 206 of the transmitter. The first through m^{th} receivers 213 to 214 each convert a signal received from a corresponding receive antenna to a baseband signal.

The STC decoder 216 calculates the Euclidean distances of the signals received from the receivers 213 to 214 over all possible sequences that could be transmitted according to a retransmission number by the transmitter. It outputs an information bit stream having the minimum Euclidean distance as a received frame. The decoding method using maximum likelihood (ML) decoding is related to the Euclidean distance.

The error detector 218 extracts an error detection code from the frame data received from the STC decoder 216 and checks errors in the frame data using the error detection code. In the absence of errors, the error detector 218 provides a success signal to the ARQ controller 220, and in the presence of errors, it provides a fail signal to the ARQ controller 220.

The ARQ controller 220 transmits an ACK or NACK signal to the transmitter according to the error check result from the error detector 218. Upon receipt of the success signal from the error detector 218, the ARQ controller 220 transmits an ACK signal to the transmission controller 207 of the transmitter on a feedback channel. Upon receipt of the fail signal from the error detector 218, the ARQ controller 220 transmits an NACK signal to the transmission controller 207 of the transmitter on the feedback channel. Meanwhile, the ARQ controller 220 provides decoding information (i.e. the retransmission number) to the STC decoder 216 to help decoding.

As described above, the receiver checks errors in the decoded frame using the error detection code. In the absence of errors in the information frame, the ARQ controller 220 requests transmission of the next frame from the transmitter by transmitting the ACK signal on the feedback channel. On the contrary, in the presence of errors in the information frame, the ARQ controller 220 requests a retransmission from the transmitter by transmitting the NACK signal on the feedback channel. The transmission controller 207 of the transmitter decides whether to transmit the next frame or to retransmit the previous frame according to the ACK/NACK signal. In the case of retransmitting the previous information frame, the transmitter transmits a frame that is different from the transmitted frame using a different code in the STC coder 202 according to the retransmission number. Changing a code is equivalent to changing generator coefficients for the STTC coder, as described before.

FIG. 3 illustrates in detail the structure of the STTC coder in the STC coder 202. The STTC coder operates in QPSK and receives two bits in parallel because one QPSK symbol is formed with two information bits. As illustrated in FIG. 3, the STTC coder includes a plurality of delays 301-1 to 301-4, a plurality of multipliers 302-1 to 302-6, and a modulo adder 303.

Referring to FIG. 3, the delays 301-1 to 301-4 each delay a received bit and output the delayed signal to the next connected delay. The multiplier 302-1 multiplies a first input bit provided to the upper delay 301-1 by a predetermined coefficient a₀. The multiplier 302-2 multiplies the delayed bit received from the delay 301-1 by a predetermined coefficient a₁. In the same manner, the multiplier 302-3 multiplies the delayed bit received from the delay 301-2 by a predetermined coefficient aᵥ₁.

The multiplier 302-4 multiplies a second input bit provided to the lower delay 301-3 by a predetermined coefficient b₀. The multiplier 302-5 multiplies the delayed bit received from the delay 301-3 by a predetermined coefficient b₁. In the same manner, the multiplier 302-6 multiplies the delayed bit received from the delay 301-4 by a predetermined coefficient bᵥ₂.

The modulo adder 303 modulo-adds the products received from the multipliers 302-1 to 302-6 and outputs a complex symbol Xₜ on a predetermined signal constellation. Because QPSK is assumed, the modulo adder 303 generates a QPSK symbol by modulo-4 addition. a₀, a₁, a₂, . . . , aᵥ₁ and b₀, b₁, b₂, . . . , bᵥ₂ are coefficients each ranging from 0 to 3. Here, v1+v2 is the length of a memory for storing an input bit stream and the number of states in the STTC coder is equal to that of memories. That is, the number of states in the STTC coder is 2^{v}^{₁}^{+v}^{₂}. In this manner, a QPSK symbol, Xₜ is created for one transmit antenna. For n transmit antennas, QPSK symbols are generated by repeating this operation or using a plurality of STTC coders illustrated in FIG. 3 in parallel.

The STTC coder illustrated in FIG. 3 can be extended to band-efficient modulation schemes such as 8PSK and QAM. For 8PSK, three memory columns are configured so as to receive three information bit streams in parallel. The input and output of the memories are processed on a bit basis and a generator coefficient to be multiplied by each bit ranges from 0 to 7. A final complex symbol is achieved by modulo-8 addition. An example of the STTC coder will be described below.

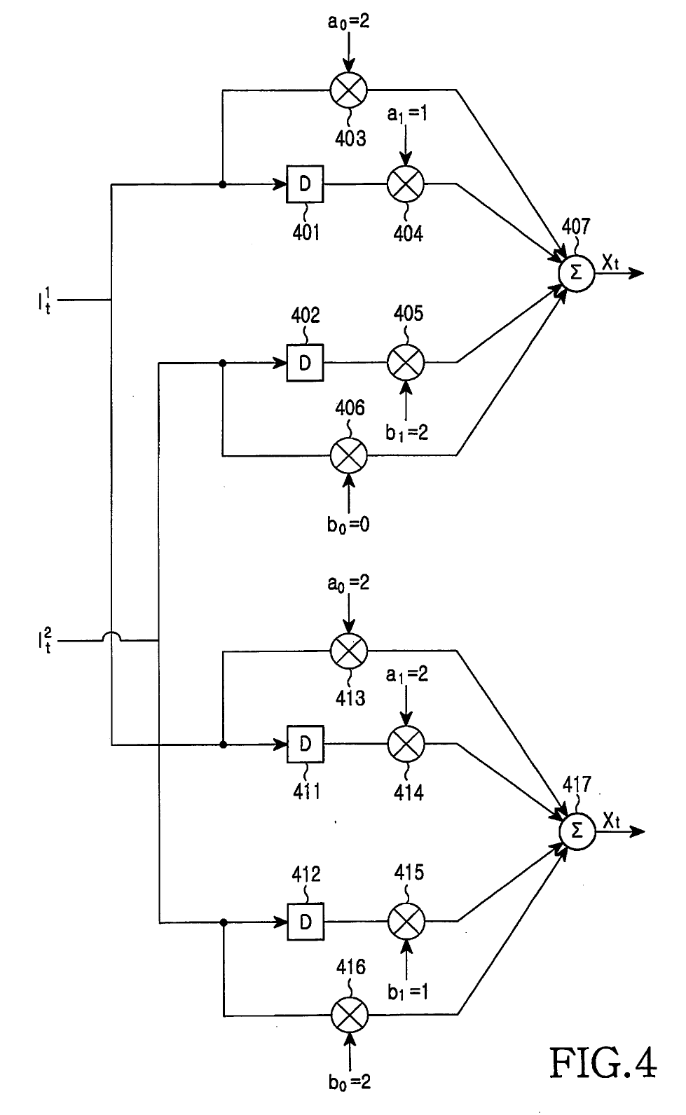

FIG. 4 illustrates the structure of an STTC coder for generating Yan's STTC for two transmit antennas and QPSK. Coders for first and second transmit antennas are identical in configuration and thus only the coder for the first transmit antenna will be described.

In the coder for the first antenna, two memories (delays) 401 and 402 are arranged in parallel because of QPSK, and receive two information bits in parallel. The delays 401 and 402 each delay an input bit for a predetermined time. A multiplier 403 multiplies a first input bit by a predetermined generator coefficient (a₀=2) and a multiplier 404 multiplies the output of the delay 401 by a predetermined generator coefficient (a₁=1). In the meantime, a multiplier 406 multiplies a second input bit by a predetermined generator coefficient (b₀=0) and a multiplier 405 multiplies the output of the delay 402 by a predetermined generator coefficient (b₁=2). A modulo adder 407 generates a complex symbol by modulo-4 adding the products received from the multipliers 403 to 406. Notably, the generator coefficients for Yan's code are optimized as a₀=2, b₀=0, a₁=1, and b₁=2.

Now a description will be made of a method for designing an optimum STC for a retransmission frame in a MIMO-HARQ system with reference to the flowchart of FIG. 5. In the absence of errors, the next frame is encoded using the same code, for transmission. In contrast, in the presence of errors, a retransmission frame is encoded using a code that is different from that used for an initial transmission frame.

Referring to FIG. 5, a variable indicating a retransmission number k is set to an initial value 0 in step 501. In step 503, it is determined whether the number of receive antennas is 1. In the case of a single receive antenna, optimum generator coefficients for the STC coder to be used at an initial transmission are decided in step 505. As described above, since Yan's code performs best for a single receive antenna, it is assumed herein that Yan's code is used as an initial transmission code.

After the generator coefficients for the initial transmission (i.e. the initial transmission code) are decided, in step 507, k is compared with a maximum retransmission number, N. If k is equal to or larger than N, the process ends. On the other hand, if k is less than N, a k^{th} retransmission code is decided using first through (k−1)^{th} retransmission codes according to the design criteria or performance criteria shown in step 509, which are as follows:

A primary design criterion is that the rank of the signal matrix of a code designed at each transmission step should be 2 or higher. The signal matrix is shown above in Equation (1). This criterion is a less strict version of the full-rank criterion.

A secondary design criterion is that the minimum squared Euclidean distance of the signal matrix of a combination code (the trace of the signal matrix being the sum of the diagonal elements) must be maximized. The combination code is created by summing the first through (k−1)^{th} retransmission codes with a k^{th} retransmission code. Although an independent STC is designed at every transmission step, it can be combined with the previous codes into one STC. Considering that the receiver decodes through code combining, it is preferred that the performance of the combination code takes priority over those of the individual codes.

A third design criterion is that the minimum determinant of the signal matrix of the k^{th} code must be maximized, in order to increase the performance of the individual STC.

Therefore, for a single receive antenna, basically, the rank of every signal matrix must be 2 or higher. Codes whose signal matrices maximize the minimum squared Euclidean distance of the signal matrix of their combination code are detected and then a code having the minimum determinant is selected as the k^{th} retransmission code among the detected codes.

After the k^{th} code satisfying the above three design criteria is detected, k is increased by 1 in step 511 and the procedure returns to step 507 and is repeated until K=N.

For two or more receive antennas, optimum generator coefficients for an initial transmission are decided for the STC coder in step 513. As stated earlier, Chen's code performs best for two or more receive antennas and thus it is assumed herein that Chen's code is used as an initial transmission code in the present invention.

After the generator coefficients for the initial transmission (i.e. the initial transmission code) are decided, in step 515, k is compared with the maximum retransmission number, N. If k is equal to or larger than N, the process ends. On the other hand, if k is less than N, a k^{th} retransmission code is decided using first through (k−1)^{th} retransmission codes according to the following design criteria or performance criteria shown in step 517, which are as follows:

A primary design criterion is that the rank of the signal matrix of a code designed at each transmission step should be 2 or higher. This criterion is a less strict version of the full-rank criterion. Full rank means that the number of the rows of the STC coding matrix (refer to Equation (1)) is equal to the number of transmit antennas. For two or more receive antennas, a rank of 2 or higher is sufficient according to the less strict rank criterion.

A secondary design criterion is that the minimum squared Euclidean distance of the signal matrix of a combination code (the trace of the signal matrix being the sum of the diagonal elements) must be maximized. The combination code is created by summing the first through (k−1)^{th} retransmission codes with a k^{th} retransmission code. Although an independent STC is designed at every transmission step, it can be combined with the previous codes into one STC. Considering that the receiver decodes through code combining, it is preferred that the performance of the combination code takes priority over those of the individual codes.

A third design criterion is that the minimum squared Euclidean distance of the signal matrix of the k^{th} code must be maximized, in order to increase the performance of the individual STC.

Therefore, for two or more receive antennas, basically, the rank of every signal matrix must be 2 or higher. Codes whose signal matrices maximize the minimum squared Euclidean distance of the matrix of their combination code are detected and then a code having the maximum minimum squared Euclidean distance is selected as the k^{th} retransmission code among the detected codes.

After the k^{th} code satisfying the above three design criteria is detected, k is increased by 1 in step 519 and the procedure returns to step 515. In this way, retransmission codes are optimized by generating the k^{th} code using the first through (k−1)^{th} codes in a recursive manner until k is equal to N.

Examples of retransmission codes generated in the procedure of FIG. 5 will be described below.

Table 1 lists generator coefficients for retransmissions when the maximum retransmission number is 3 and the initial transmission code (i.e., the initial generator coefficients) is Yan's code in an STC QPSK system with two transmit antennas and one receive antenna.

TABLE 1

| | 4-state | 8-state | 16-state | 32-state |
|---|---|---|---|---|
| Initial | 2012 | 20012 | 021120 | 0221212 |
| transmission | 2221 | 12202 | 221202 | 2210022 |
| (Yan's code) | | | | |
| Retransmission 1 | 0221 | 12200 | 021320 | 2021221 |
| (k = 1) | 2102 | 21212 | 202122 | 2113200 |
| Retransmission 2 | 0212 | 12200 | 201202 | 0221210 |
| (k = 2) | 2120 | 22221 | 222012 | 2133222 |
| Retransmission 3 | 0212 | 12202 | 022122 | 0212220 |
| (k = 3) | 2120 | 21220 | 200221 | 2020212 |

A 4-state STC coder for generating Yan's STTC as an initial transmission code using generator coefficients illustrated in Table 1 has the configuration illustrated in FIG. 3.

Table 2 lists generator coefficients for retransmissions when the maximum retransmission number is 3 and the initial transmission code (i.e., the initial generator coefficients) is Chen's code in an STC QPSK system with two transmit antennas and two receive antennas.

TABLE 2

| | 4-state | 8-state | 16-state | 32-state |
|---|---|---|---|---|
| Initial | 0212 | 22210 | 121232 | 0221122 |
| transmission | 2320 | 20122 | 203220 | 2232230 |
| Retransmission 1 | 0221 | 02210 | 022021 | 2012230 |
| (k = 1) | 2121 | 21212 | 222102 | 2120102 |
| Retransmission 2 | 1212 | 12202 | 120212 | 0221210 |
| (k = 2) | 2012 | 21210 | 202121 | 2120122 |
| Retransmission 3 | 0212 | 02210 | 022102 | 0221200 |
| (k = 3) | 2120 | 21212 | 212321 | 2122122 |

If the initial code is still retransmitted, the minimum squared Euclidean distance at the retransmission is larger than that at the initial transmission by as many times as the number of transmissions. That is, the minimum Euclidean distance of a retransmission code is larger than that of an initial transmission code by as many times as the number of transmissions, and as expected offers improved performance. For example, if an 8-state Chen's code is used as an initial transmission code for two transmit antennas, the minimum squared Euclidean distance is 12. In the case of chase combining, the initial transmission code is still retransmitted. Therefore, the minimum squared Euclidean distances of codes received at the receiver are as follows:
Initial transmission: 12
Second transmission (initial retransmission): 24 (12×2)
Third transmission (second retransmission): 36 (12×3)
Fourth transmission (third retransmission): 48 (12×4)

In comparison, the use of the retransmission codes of the present invention illustrated in Table 2 increases the minimum squared Euclidean distance as follows:
Initial transmission: 12
Second transmission (initial retransmission): 26
Third transmission (second retransmission): 40
Fourth transmission (third retransmission): 52

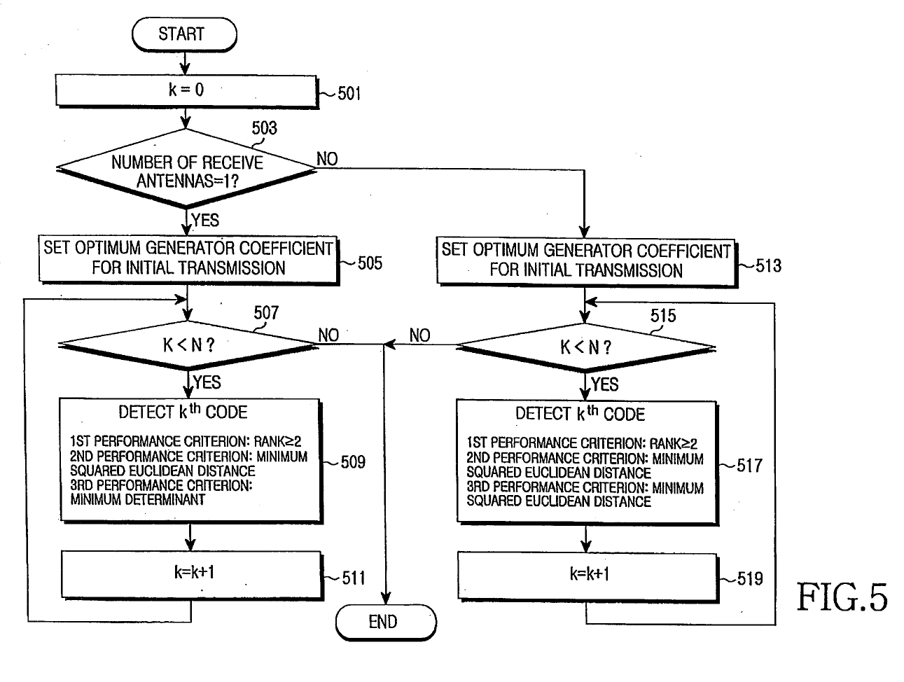

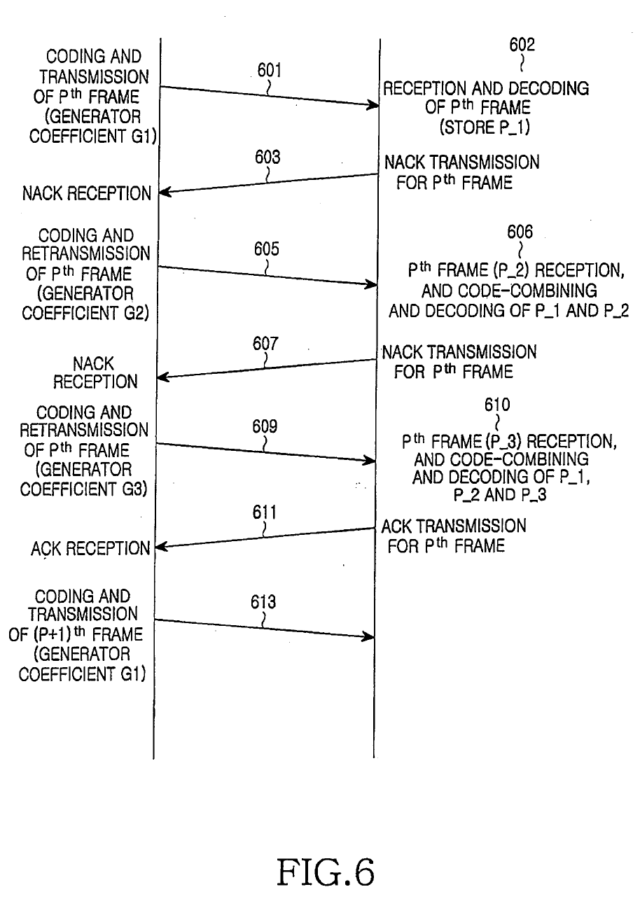

FIG. 6 illustrates a signal flow for the operation of the HARQ system using retransmission codes according to an embodiment of the present invention.

Referring to FIG. 6, the transmitter STTC-encodes a P^{th} frame using a generator coefficient G1 and transmits the P^{th} frame in step 601. In step 602, the receiver decodes the P^{th} frame and checks for errors in the decoded P^{th} frame. At the same time, the receiver stores the P^{th} frame as frame P_1 in a memory. Upon detection of errors in the P^{th} frame, the receiver transmits an NACK signal to the transmitter, requesting a retransmission of the P^{th} frame in step 603.

In step 605, the transmitter STTC-encodes the P^{th} frame using a generator coefficient G2 and transmits the P^{th} frame, instead of transmitting a (P+1)^{th} frame. The receiver combines the retransmission frame (i.e. frame P_2) with frame P_1, decodes the combined frame, and checks for errors in the decoded frame using an error detection code in step 606. Upon detection of errors, the receiver transmits an NACK signal to the transmitter in step 607 and the transmitter STTC-encodes the P^{th} frame using a generator coefficient G3 and transmits it in step 609.

In step 610, the receiver combines the current retransmission frame (i.e., frame P_3), frame P_2, and frame P_1, decodes the combined frame, and checks for errors in the decoded frame. In the absence of errors, the receiver transmits an ACK signal to the transmitter in step 611. In step 613, the transmitter STTC-encodes the (P+1)^{th} frame using the generator coefficient G1 and transmits the (P+1)^{th} frame to the receiver.

The generator coefficients G1, G2 and G3 are optimized in the method illustrated in FIG. 5. For a QPSK system with two transmit antennas, optimum generator coefficients are illustrated in Table 1 and Table 2.

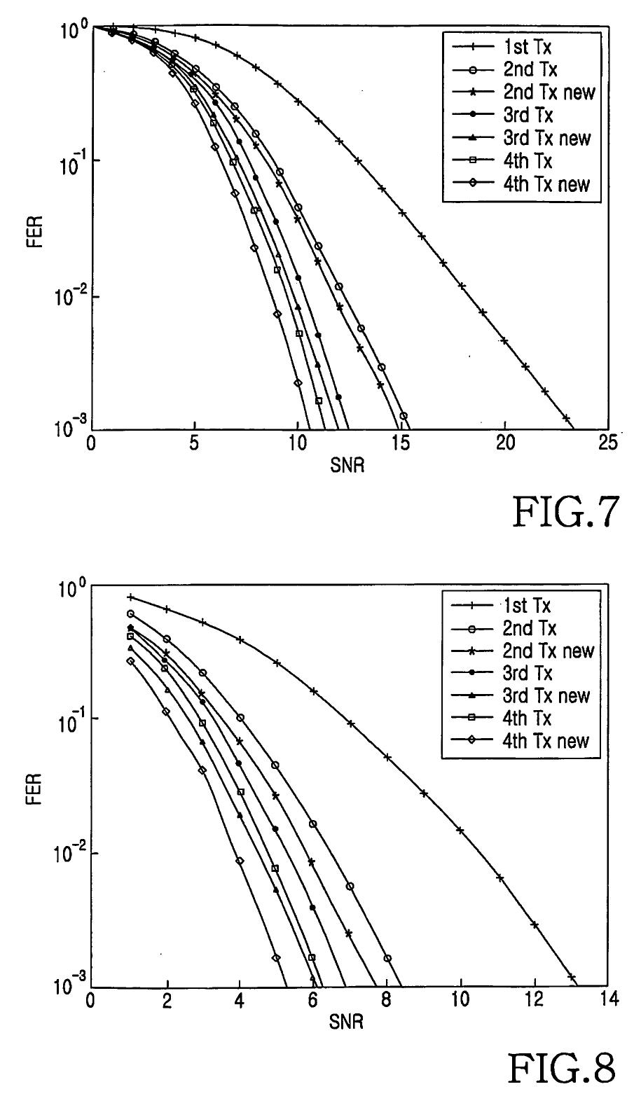

A comparison in performance between the retransmission scheme of the present invention and a conventional retransmission scheme will be given with reference to the graphs of FIGS. 7-9.

FIG. 7 is a graph comparing in terms of performance the retransmission scheme of the present invention (32-state in Table 1) with a retransmission scheme in which Yan's code is chase-combined. The performance was evaluated under a quasi-static fading channel environment. The horizontal axis represents signal-to-noise ratio (SNR) and the vertical axis represents frame error rate (FER). It is noted from FIG. 7 that at an FER of 10⁻³, the present invention provides a higher code performance than the chase combining of Yan's code (1^{st} Tx) by 0.5 dB or above at second, third and fourth transmissions (i.e. first, second and third retransmissions).

FIG. 8 is a graph comparing in terms of performance the retransmission scheme of the present invention (32-state in Table 2) with a retransmission scheme in which Chen's code is chase-combined. The performance was evaluated under a quasi-static fading channel environment. The horizontal axis represents SNR and the vertical axis represents FER. It is noted from FIG. 8 that at an FER of 10⁻³, the present invention provides a higher code performance than the chase combining of Chen's code (1^{st} Tx) by 1 dB or above at second, third and fourth transmissions (i.e. first, second and third retransmissions).

In general, the ARQ system defines performance in terms of throughput. Throughput is a measure of how much unit information can be sent at a given SNR to a receiver.

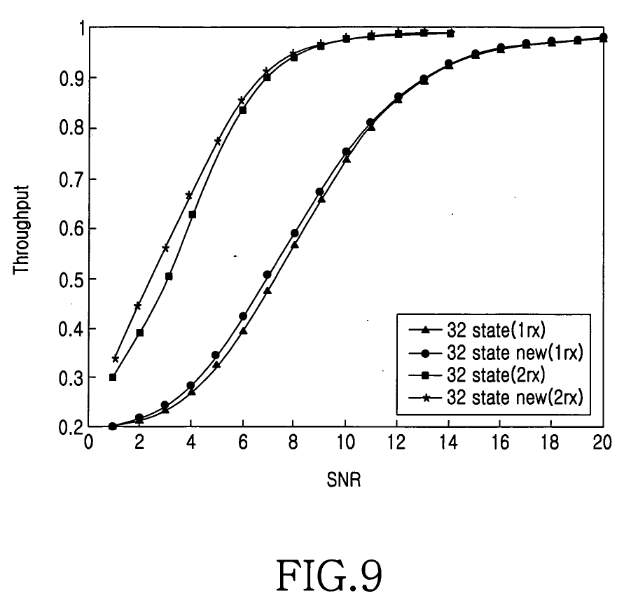

FIG. 9 is a graph illustrating the throughputs of chase combining of Yan's code (32 state 1rx), 32-state of Table 1 (32 state new 1rx), chase combining of Chen's code (32 state 2rx), and 32-state of Table 2 (32 state new 2rx). As noted from the graph, the retransmission method of the present invention achieves throughput gains in a low SNR range, compared to the cases of retransmitting an identical initial transmission code and decoding it by chase combining.

As described above, the present invention provides an optimum STC for a MIMO-HARQ system. This optimum STC leads to a higher link-level performance under the same conditions, thereby increasing system throughput.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for designing a space-time code (STC) for a k^{th} retransmission in a hybrid automatic repeat request (HARQ) system, comprising the steps of:
detecting k^{th} codes that maximize a minimum squared Euclidean distance of a signal matrix of a combination code created by combining first to (k−1)^{th} codes with a k^{th} code; and
selecting a k^{th} code whose signal matrix has a maximum minimum determinant as the k^{th} retransmission code.

2. The method of claim 1, wherein the detecting step comprises:
generating a plurality of combination codes by combining the first to (k−1)^{th} codes with all possible individual codes;
calculating the minimum squared Euclidean distance of the signal matrix of each of the generated combination codes; and
selecting the k^{th} codes which maximize the minimum squared Euclidean distance.

3. The method of claim 1, wherein an initial transmission code for k=0 is Yan's code.

4. The method of claim 1, wherein the signal matrix of the k^{th} retransmission code has a rank of 2 or higher.

5. The method of claim 1, wherein the minimum squared Euclidean distance of a code is the trace of the signal matrix of the code.

6. The method of claim 1, wherein the signal matrix of a code is defined as (c−e)(c−e)* where c denotes the code and e denotes an error code for the code, and * denotes a transpose conjugate.

7. The method of claim 1, wherein the STC is a space-time trellis code (STTC).

8. The method of claim 7, wherein for two transmit antennas and one receive antenna in quadrature phase shift keying (QPSK), the following retransmission codes are used for the STTC according to a number of states for the STTC,

| | 4-state | 8-state | 16-state | 32-state |
|---|---|---|---|---|
| Initial | 2012 | 20012 | 021120 | 0221212 |
| transmission | 2221 | 12202 | 221202 | 2210022 |
| (Yan's code) | | | | |
| Retransmission 1 | 0221 | 12200 | 021320 | 2021221 |
| (k = 1) | 2102 | 21212 | 202122 | 2113200 |
| Retransmission 2 | 0212 | 12200 | 201202 | 0221210 |
| (k = 2) | 2120 | 22221 | 222012 | 2133222 |
| Retransmission 3 | 0212 | 12202 | 022122 | 0212220 |
| (k = 3) | 2120 | 21220 | 200221 | 2020212 |

9. A method for designing a space-time code (STC) for a k^{th} retransmission in a hybrid automatic repeat request (HARQ) system, comprising the steps of:
detecting k^{th} codes that maximize a minimum squared Euclidean distance of a signal matrix of a combination code created by combining first to (k−1)^{th} codes with a k^{th} code; and
selecting a k^{th} code whose signal matrix has a minimum squared Euclidean distance as the k^{th} retransmission code.

10. The method of claim 9, wherein the detecting step comprises:
generating a plurality of combination codes by combining the first to (k−1)^{th} codes with all possible individual codes;
calculating the minimum squared Euclidean distance of the signal matrix of each of the generated combination codes; and
selecting the k^{th} codes which maximize the minimum squared Euclidean distance.

11. The method of claim 9, wherein an initial transmission code for k=0 is Chen's code.

12. The method of claim 9, wherein the signal matrix of the k^{th} retransmission code has a rank of 2 or higher.

13. The method of claim 9, wherein the minimum squared Euclidean distance of a code is the trace of the signal matrix of the code.

14. The method of claim 9, wherein the signal matrix of a code is defined as (c−e)(c−e)* where c denotes the code, e denotes an error code for the code, and * denotes a transpose conjugate.

15. The method of claim 9, wherein the STC is a space-time trellis code (STTC).

16. The method of claim 15, wherein for two transmit antennas and two receive antennas in quadrature phase shift keying (QPSK), the following retransmission codes are used for the STTC according to the number of states for the STTC,

| | 4-state | 8-state | 16-state | 32-state |
|---|---|---|---|---|
| Initial | 0212 | 22210 | 121232 | 0221122 |
| transmission | 2320 | 20122 | 203220 | 2232230 |
| (Yan's code) | | | | |
| Retransmission 1 | 0221 | 02210 | 022021 | 2012230 |
| (k = 1) | 2121 | 21212 | 222102 | 2120102 |
| Retransmission 2 | 1212 | 12202 | 120212 | 0221210 |
| (k = 2) | 2012 | 21210 | 202121 | 2120122 |
| Retransmission 3 | 0212 | 02210 | 022102 | 0221200 |
| (k = 3) | 2120 | 21212 | 212321 | 2122122 |
